(19) United States
(12) Patent Application Publication
(10) Pub. No.: US 2007/0251693 A1
(43) Pub. Date: Nov. 1, 2007

(54) Compositions and methods for delivering an organic solvent to a downhole portion of a wellbore or to a portion of a pipeline

(75) Inventors: Gary J. Cheramie, Lafayette, LA (US); Richard W. Pauls, Duncan, OK (US)

Correspondence Address: Halliburton Energy Services, Inc., 2600 S. 2nd Street, Ducan, OK, 73536-0440, US

(73) Assignee: Halliburton Energy Services, Inc.

(21) Appl. No.: 11/787,887

(22) Filed: Apr. 18, 2007

Related U.S. Application Data
(60) Provisional application No. 60/795,671, filed on Apr. 28, 2006.

(51) Int. Cl. E21B 37/00; C09K 8/524

(52) U.S. Cl. 166/300; 166/304; 166/312; 507/930; 507/931; 507/90

(57) ABSTRACT

A composition is provided for delivering an organic solvent to a downhole portion of a wellbore for the production of hydrocarbon or to a portion of a pipeline for the transmission of hydrocarbon. The composition comprises: (A) water; (B) a weighting agent; (C) an organic solvent that is immiscible with water; and (D) a surfactant adapted for forming an oil-external emulsion of the organic solvent and the water, wherein the surfactant is unstable to hydrolysis. The composition is formed to be an oil-external emulsion. The density of the composition is formulated to be greater than that of pure water at standard temperature and pressure. A method is provided for delivering an organic solvent to a downhole portion of a wellbore for the production of hydrocarbon or to a portion of a pipeline for the transmission of hydrocarbon. The method comprises the steps of: (A) forming a composition according to the invention; and (B) introducing the composition into the wellbore or into the pipeline.

### CROSS-REFERENCE TO RELATED APPLICATIONS

This application claims the benefit of U.S. Provisional Application Ser. No. 60/795,671, filed Apr. 28, 2006, entitled “Compositions and Methods for Delivering an Organic Solvent to a Downhole Portion of a Wellbore,” which is incorporated herein by reference in its entirety.

### STATEMENT REGARDING FEDERALLY SPONSORED RESEARCH OR DEVELOPMENT

Not applicable.

### REFERENCE TO MICROFICHE APPENDIX

Not applicable.

### TECHNICAL FIELD

In general, the invention relates to producing hydrocarbon by drilling a wellbore into the earth, whether on land or subsea, to reach a hydrocarbon-bearing reservoir and producing hydrocarbon through the wellbore. In addition, the invention relates to the transmission of such hydrocarbons through a pipeline. More particularly, the invention relates to the problem of dissolving or removing oil-soluble materials, for example asphaltenes, paraffin, and oil-soluble diverting agents, pipe dope, grease, and any combination thereof, from a wellbore or from a pipeline.

### SUMMARY OF THE INVENTION

According to one aspect of the invention, a composition for delivering an organic solvent to a downhole portion of a wellbore for the production of hydrocarbon or to a portion of a pipeline for the transmission of hydrocarbon. The composition comprises: (A) water; (B) a weighting agent; (C) an organic solvent that is immiscible with water; and (D) a surfactant adapted for forming an oil-external emulsion of the organic solvent and the water, wherein the surfactant is unstable to hydrolysis. The composition is formed to be an oil-external emulsion. The density of the composition is formulated to be greater than that of pure water at standard temperature and pressure.

According to another aspect of the invention, a method is provided for delivering an organic solvent to a downhole portion of a wellbore for the production of hydrocarbon or to a portion of a pipeline for the transmission of hydrocarbon. The method comprises the steps of: (A) forming a composition according to the invention; and (B) introducing the composition into the wellbore or into the pipeline.

### DETAILED DESCRIPTION OF PREFERRED EMBODIMENTS

As used herein, the words “comprise,” “has,” and “include” and all grammatical variations thereof are each intended to have an open, non-limiting meaning that does not exclude additional elements or steps.

As used herein, the words “uphole” and “downhole” refer to directions or portions of a wellbore that are relative to the direction of the flow of fluid toward the surface, regardless of the vertical or horizontal orientation of the particular section of wellbore.

According to one aspect of the invention, a composition for delivering an organic solvent to a downhole portion of a wellbore for the production of hydrocarbon or to a portion of a pipeline for the transmission of hydrocarbon. The composition comprises: (A) water; (B) a weighting agent; (C) an organic solvent that is immiscible with water; and (D) a surfactant adapted for forming an oil-external emulsion of the organic solvent and the water, wherein the surfactant is unstable to hydrolysis. The composition is formed to be an oil-external emulsion. The density of the composition is formulated to be greater than that of pure water at standard temperature and pressure.

According to a preferred embodiment of the invention, the weighting agent is a water soluble salt. For example, the water and the weighting agent can comprise a brine.

For example, it is also contemplated that the weighting agent can be selected from the group consisting of: clay, barium sulfate, hematite, and any combination thereof. In these cases the weighting agent can be dispersed in either the aqueous phase or the organic solvent phase of the composition, or, if desired, even in both phases.

For example, the organic material to be removed can be selected from the group consisting of: asphaltenes, paraffins, oil-soluble diverting agents, pipe dope, grease, and any combination thereof. The oil-soluble diverting agent can comprise, for example, a resin.

The organic solvent should be immiscible with water, otherwise the solvent will not form an emulsion with water or an aqueous solution. An appropriate organic solvent for use in the composition is next selected based primarily on its being effective to dissolve the particular organic material or materials desired to be removed from the wellbore or the pipeline. Another important consideration in selecting the organic solvent is that it should not be incompatible with the formation fluids to avoid the formation of undesirable precipitates or residues, etc. Other considerations for the selection of an appropriate organic solvent include that it should not tend to poison any catalysts used in the refining of the hydrocarbon produced from the well or transmitted through the pipeline. For example, halogenated organic materials can be of concern for the possibility of poisoning such catalysts. Still further considerations in selecting an appropriate solvent include any environmental or regulatory considerations, and of course, cost considerations. Preferably, the organic solvent is selected from the group consisting of: aromatic solvents, terpene solvents, and any combination thereof. Such organic solvents are particularly useful for dissolving asphaltenes, paraffins, and oil-soluble diverting agents. For example, the organic solvent preferably comprises xylene. Aliphatic organic solvents, such as kerosene and diesel, can be particularly useful for helping to remove paraffins, for example.

According to the presently most preferred embodiment of the invention, the surfactant comprises a fatty acid ester. A suitable example of such a surfactant is commercially available from Halliburton Energy Services, of Duncan, Okla., under the product designation “AF-61.”

Preferably, the composition is an emulsion having a ratio of about 25% to about 90% by volume of an internal aqueous phase and in the range of about 75% to about 10% by volume of an external organic solvent phase. More preferably, the composition is an emulsion having a ratio in the range of about 50% to about 80% by volume of an internal aqueous phase and in the range of about 20% to about 50% by volume of an external organic solvent phase. The appropriate range of ratios of aqueous phase to organic solvent phase and the sufficient shear conditions to form an emulsion will depend on the particular aqueous phase and solvent phase employed.

According to a presently most preferred embodiment of the invention, the composition is adapted such that when an emulsion of the composition is subjected to a temperature of about 200° F., the emulsion breaks within a period of about 4 hours.

According to another aspect of the invention, a method for delivering an organic solvent to a downhole portion of a wellbore for the production of hydrocarbon or to a portion of a pipeline for the transmission of hydrocarbon is provided. The method comprises the step of: forming a composition comprising: (i) water; (ii) a weighting agent; (iii) an organic solvent that is immiscible with water; (iv) a surfactant adapted for forming an oil-external emulsion of the organic solvent and the water, wherein the surfactant is unstable to hydrolysis. The composition is formed to be an oil-external emulsion. The density of the composition is formulated to be greater than that of pure water at standard temperature and pressure. The method further comprises the step of: introducing the composition into the wellbore or into the pipeline.

Preferably, the step of forming the composition further comprises the step of: prior to mixing with the organic solvent, mixing the water and the weighting agent to form a weighted aqueous fluid.

According to a more preferred embodiment of the method, the water and the weighting agent are brine. Preferably, the step of forming the composition further comprises the step of: prior to mixing with the brine, mixing the organic solvent with the surfactant to dissolve the surfactant in the organic solvent.

The mixing of the brine and the mixture of the surfactant dissolved in the organic solvent can be in a batch process. In a batch method, the step involves slowly adding the brine to the mixture of the surfactant dissolved in the organic solvent in an appropriate ratio and under sufficient under sufficient shear conditions to form an emulsion.

The mixing of the brine and the mixture of the surfactant dissolved in the organic solvent can be in a continuous process or “on the fly.” On the fly, the step involves mixing a stream of the brine with a stream of the mixture of the surfactant dissolved in the organic solvent in an appropriate ratio and under sufficient shear conditions to form an emulsion.

Preferably, the composition is weighted to have a sufficient density to displace an aqueous fluid present in the wellbore or the pipeline. For example, in a case wherein the downhole portion of the wellbore or the portion of the pipeline is a horizontal interval, the composition is weighted to have a sufficient density to displace an aqueous fluid present in the horizontal interval. This will better ensure that the bottom portion of the horizontal interval is treated.

When the surfactant is exposed to the water in the composition, the surfactant hydrolyzes over time to become unable to perform the function of an emulsifying surfactant. Over time, the emulsion of the emulsified composition becomes unstable and breaks.

According to a preferred embodiment of the invention, the step of introducing the composition into the wellbore preferably further comprises the step of: placing the composition in the downhole portion of the wellbore or the portion of the pipeline for a sufficient contact time for the organic solvent therein to dissolve a substantial amount of an organic material present in the wellbore or the pipeline. Further, the method preferably further comprises the steps of: after placing the composition in the downhole portion of the wellbore or the pipeline, allowing the composition to break, and then flowing back the organic solvent with some of the organic material dissolved therein from the wellbore or from the pipeline.

The invention has application in coiled tubing, sand control, stimulation, well completions, and well intervention operations. This invention is well adapted to treat longer, deeper, hotter producing zones. A treatment using a composition or method according to the invention provides the benefit that the treatment fluid is weighted and emulsified, and that the emulsion breaks relatively quickly, especially after it reaches an elevated bottom hole temperature. Another application for the invention is for cleaning drilling fluids from casing in wells during displacements or anytime during the drilling, completion, work-over or production of a well. Yet another application is for cleaning paraffin(s) and asphaltene(s) deposits from production tubing, surface production equipment and separators, and pipelines during the drilling, completion, work-over, or production of a well. Still another application for the invention is for cleaning pipelines of organic deposits, such as paraffin(s) and asphaltene(s) deposits.

Therefore, the present invention is well adapted to carry out the objects and attain the ends and advantages mentioned as well as those that are inherent therein. While those skilled in the art may make numerous changes, such changes are encompassed within the spirit of this invention as defined by the appended claims.

What is claimed is:

1. A method for delivering an organic solvent to a downhole portion of a wellbore for the production of hydrocarbon or to a portion of a pipeline for the transmission of hydrocarbon, the method comprising the steps of:
(A) forming a composition comprising:
(i) water;
(ii) a weighting agent;
(iii) an organic solvent that is immiscible with water;
(iv) a surfactant adapted for forming an oil-external emulsion of the organic solvent and the water, wherein the surfactant is unstable to hydrolysis;
wherein the composition is formed to be an oil-external emulsion; and
wherein the density of the composition is formulated to be greater than that of pure water at standard temperature and pressure;
(B) introducing the composition into the wellbore or pipeline.

2. The method according to claim 1, wherein the step of forming the composition further comprises the step of: prior to a step of mixing with the organic solvent, a step of mixing the water and the weighting agent to form a weighted aqueous fluid.

3. The method according to claim 1, wherein the water and the weighting agent are brine.

4. The method according to claim 3, wherein the step of forming the composition further comprises the step of: prior to a step of mixing with the brine, a step of mixing the organic solvent with the surfactant to dissolve the surfactant in the organic solvent.

5. The method according to claim 4, further comprising the step of: in a batch, slowly adding the brine to the mixture of the surfactant dissolved in the organic solvent in an appropriate ratio and under sufficient shear conditions to form an emulsion.

6. The method according to claim 4, further comprising the step of: on the fly, mixing a stream of the brine with a stream of the mixture of the surfactant dissolved in the organic solvent in an appropriate ratio and under sufficient shear conditions to form an emulsion.

7. The method according to claim 1, wherein the composition is weighted to have a sufficient density to displace an aqueous fluid present in the wellbore or pipeline.

8. The method according to claim 1, wherein the downhole portion of the wellbore or the portion of the pipeline is a horizontal interval, and wherein in the step of forming the composition, the composition is weighted to have a sufficient density to displace an aqueous fluid present in the horizontal interval.

9. The method according to claim 1, wherein the step of introducing the composition into the wellbore or the portion of the pipeline further comprises the step of: placing the composition in the downhole portion of the wellbore or the portion of the pipeline for a sufficient contact time for the organic solvent therein to dissolve a substantial amount of an organic material present in the wellbore or the pipeline.

10. The method according to claim 9, further comprising the steps of: after placing the composition in the downhole portion of the wellbore or the portion of the pipeline, allowing the composition to break, and then flowing back the organic solvent with some of the organic material dissolved therein from the wellbore or the pipeline.

11. The method according to claim 1, wherein the weighting agent is a water soluble salt.

12. The method according to claim 11, wherein the water and the weighting agent comprise a brine.

13. The method according to claim 1, wherein the weighting agent is selected from the group consisting of: clay, barium sulfate, hematite, and any combination thereof.

14. The method according to claim 1, wherein the organic solvent is further selected for being effective to dissolve an organic material selected from the group consisting of: asphaltenes, paraffins, oil-soluble diverting agents, pipe dope, grease, and any combination thereof.

15. The method according to claim 14, wherein the organic material is an oil-soluble diverting agent comprising a resin.

16. The method according to claim 1, wherein the organic solvent is selected from the group consisting of: aromatic solvents, terpene solvents, kerosene, diesel, and any combination thereof.

17. The method according to claim 1, wherein the organic solvent comprises xylene.

18. The method according to claim 1, wherein the surfactant comprises a fatty acid ester.

19. The method according to claim 1, wherein the composition is an emulsion having a ratio of about 25% to about 90% by volume of an internal aqueous phase and in the range of about 75% to about 10% by volume of an external organic solvent phase.

20. The method according to claim 1, wherein the composition is adapted such that when subjected to a temperature of about 200° F., the emulsion breaks within a period of about 4 hours.

21. A method for delivering an organic solvent to a downhole portion of a wellbore for the production of hydrocarbon or to a portion of a pipeline for the transmission of hydrocarbon, the method comprising the steps of:
(A) forming a composition comprising:
(i) water;
(ii) a weighting agent;
(iii) an organic solvent that is immiscible with water, wherein the organic solvent is further selected for being effective to dissolve an organic material from the wellbore selected from the group consisting of: asphaltenes, paraffins, oil-soluble diverting agents, pipe dope, grease, and any combination thereof;
(iv) a surfactant adapted for forming an oil-external emulsion of the organic solvent and the water, wherein the surfactant comprises a fatty acid ester that is unstable to hydrolysis;
wherein the composition is formed to be an oil-external emulsion; and
wherein the density of the composition is formulated to be greater than that of pure water at standard temperature and pressure;
(B) introducing the composition into the wellbore or the pipeline.
